(19) United States
(12) Patent Application Publication
(10) Pub. No.: US 2013/0027526 A1
(43) Pub. Date: Jan. 31, 2013

(54) UNIVERSAL ACTIVE 3D STEREO SHUTTER GLASSES

(71) Applicant: Xiaodong Mao, Foster City, CA (US)

(72) Inventor: Xiaodong Mao, Foster City, CA (US)

(73) Assignee: SONY COMPUTER ENTERTAINMENT INC., Toyko (JP)

(21) Appl. No.: 13/637,799

(22) PCT Filed: Aug. 27, 2010
(86) PCT No.: PCT/US10/47029

§ 371 Date: Sep. 27, 2012

Related U.S. Application Data
(60) Provisional application No. 61/326,153, filed on Apr. 20, 2010.

(51) Int. Cl. H04N 13/04

(52) U.S. Cl. 348/56; 348/E13.04

(57) ABSTRACT

Stereoscopic 3-D active shutter glasses with multiple IR, RF, and other receivers configured for different TV brands are presented. In some embodiments, the multiple receivers and their accompanying logic circuits can be embedded in the glasses and selected automatically from a lookup table. Various logic for demodulating or otherwise decoding signals can be downloaded off the Internet for different brands. In other embodiments, each receiver and accompanying logic circuit can be plugged in to the glasses as a separate module corresponding to each brand or TV model.

### CROSS-REFERENCES TO RELATED APPLICATIONS

This application claims the benefit of U.S. Provisional Application No. 61/326,153, filed Apr. 20, 2010, hereby incorporated by reference in its entirety for all purposes.

### BACKGROUND

1. Field of the Art

Embodiments of the present invention relate to electronic devices for viewing stereographic displays and, in particular, to actively shuttered three-dimensional (“3-D” or “3D”) glasses synchronized in time with 3-D enabled televisions.

2. Description of the Related Art

Televisions (TVs), monitors, and other displays have evolved over the years from black and white images to color, analog signals to digital high definition television (HDTV) formats, and cathode ray tube (CRT) screens to plasma and liquid crystal display (LCD) technologies. Three-dimensional ready televisions may be the next major upgrade that the general public endorses by buying in large quantities.

Three-dimensional ready televisions commonly incorporate stereoscopic displays. Stereoscopic displays present a separate image to a viewer's left eye and a separate image to the viewer's right eye. Technologies to present separate images to a viewer's eyes include anaglyphs, which typically use red and blue lens glasses, polarized lens glasses, and active shutter lens glasses for actively blocking the viewer's eyes in rapid, period sequence. All such lenses for 3-D glasses are typically non-corrective lenses in that they do not redirect the direction of light.

For many 3-D ready televisions coming to market, their manufactures have developed vendor-unique protocols based on active shutter techniques. With active shutter techniques, a 3-D television rapidly (e.g., greater than 30 frames per second) and alternatingly shows separate images for a viewer's left and right eyes. The viewer wears glasses that have liquid crystal (LC) active shutters rapidly blocking the left and right eye views alternatively so that each eye sees the corresponding left and right images shown at the corresponding time on the display. This “active shutter” process preferably is periodically and/or continuously synchronized with synchronization signals transmitted from the TV.

Currently, using an infrared (IR) link for transmitting a synchronization signal from the television to the glasses has proven both technologically efficient and economically affordable. Hence, an IR link has become the de-facto consensus for many major TV brands.

Current IR links are comprised of at least two parts: (1) an IR transmitter, either built-in inside the TV front panel or external as peripheral; and (2) an IR receiver built-in on the frame of the 3D glasses.

The television feeds the IR transmitter with left/right image display clock signals. The transmitter either modulates the clock signal on the near infrared spectrum at a center frequency F0 and then blasts the modulated infrared light or directly blasts the infrared light at center frequency F0 with on/off beeping that encodes the clock signal.

The IR receiver on the 3D glasses is calibrated to the center frequency F0 (with an IR pass filter, which can be a physical lens shutter). The received IR light is then either demodulated or otherwise decoded as a synchronization signal for left and right eye views to control the active shutter on the glasses.

Currently, many television manufacturers use a specific F0 and IR light pattern (either modulation based or simple beeping), which means that many 3D-ready TVs require proprietary sets of glasses that are compatible with them. Because they are proprietary and produced for the relatively limited market of each television manufacturer or brand, the 3-D glasses can be expensive for the seller to produce and expensive for consumers to purchase. Elevated costs are often passed on to the consumer because once a consumer has bought a particular manufacturer's 3-D television, the manufacturer has a captive market to which to sell compatible 3-D glasses.

### BRIEF SUMMARY

Universal stereoscopic 3-D active shutter glasses are presented that can be used with many, if not most, major brands of 3-D televisions, monitors, and other displays. In some embodiments, multiple IR, radio frequency (RF), and/or other receivers are mounted to the glasses. Each receiver can receive synchronization signals from one or more brands of televisions. The receivers are connected with logic circuits that convey a synchronization signal to the shutter logic of the glasses. A receiver/logic circuit pair can be selected by a consumer so that the 3-D glasses are compatible with his or her 3-D television.

In some embodiments, each receiver and accompanying logic circuit can be plugged in to the glasses as a separate module corresponding to each TV brand or model. This ‘selection’ of a receiver and logic circuit by the user allows him or her the flexibility to use the glasses for different 3-D televisions.

For universal 3-D glasses that are capable of working with a large number of 3D-ready TVs and monitors across a variety of manufacturers, at least two problems are hereby identified: (a) there is a variation in the IR center frequency F0 between manufacturers or brands; and (b) there is a variation in the transmitted IR light pattern between manufacturers or brands.

For problem (a), an F0-adjustable lens can be developed, or multiple lens can be provided in a product package. Typically for current 3-D TVs, center frequency F0 is in the range of 20 kHz to 28 kHz with on/off pulses of IR light. Practically, about 4 to 6 or 8 different IR receivers can pretty much cover major F0 choices given common interference problems. That only 4 to 6 or 8 different IR receivers are required to cover the plethora of manufacturers, brands, and models of 3-D enabled televisions on the market means that the receivers can all fit on a pair of glasses without making the glasses too bulky. A small number of different receivers may make such a design commercially viable.

For problem (b), an IR signaling pattern can be decoded in a laboratory with spectrum analyzer equipment capable of intercepting IR light. The resulting decoded signaling pattern can be either dynamically downloaded to glasses by users (e.g., by connecting the glasses through a universal serial bus (USB) port to a personal computer (PC), video game console, or other electronic device with a processor and memory and downloading the signaling pattern by selecting a TV model), or the signaling pattern can be built into an IR receiver module. For example, a Sony Bravia®-compatible IR receiver can be consolidated in the glasses along with other IR receivers.

The IR receiver module on glasses is one key to solving the compatibility over variety of 3D-ready TVs. RF receivers can also be analyzed with spectrum analyzer equipment capable of intercepting RF. IR receivers, RF receivers, and other receiver types can be mixed and matched on the same pair of glasses by designers according to market demand and the availability and cost of components.

Embodiments of the present disclosure relate to an apparatus for viewing a stereoscopic display, including a pair of active shutter lenses, each lens enabled to alternate opacity and transparency, means for positioning the lenses in front of a viewer's eyes, and a plurality of receivers including a first receiver configured to receive a first synchronization signal and a second receiver configured to receive a second synchronization signal. The apparatus further includes a circuit connected to the active shutter lenses and plurality of receivers, the circuit configured to control alternating opacity and transparency of the lenses based on a selected synchronization signal and a selector operatively coupled to the circuit, the selector enabled to select the selected synchronization signal from one of the first and second synchronization signals.

Some embodiments relate to an apparatus for viewing a stereoscopic display, including a frame, active shutter lenses attached to the frame, each lens enabled to alternate opacity and transparency, and an electrical connector attached to the frame. The apparatus further includes a first removable receiver removably attached to the electrical connector, the first removable receiver configured to receive a first synchronization signal, and a circuit connected to the electrical connector and active shutter lenses, the circuit configured to control alternating opacity and transparency of the lenses based on a synchronization signal received by the first removable receiver.

Some embodiments relate to a method of operating 3-D active shutter glasses, the method including receiving a synchronization signal for a stereoscopic display, selecting a receiver and a logic circuit corresponding to the synchronization signal from a plurality of receivers and logic circuits coupled to 3-D active shutter glasses, storing in a memory the selection, and shuttering active lenses of the 3-D active shutter glasses using the selected receiver and logic circuit.

A further understanding of the nature and the advantages of the embodiments disclosed and suggested herein may be realized by reference to the remaining portions of the specification and the attached drawings.

### BRIEF DESCRIPTION OF THE DRAWINGS

FIG. 1A illustrates 3-D glasses with multiple embedded receivers corresponding to an embodiment.

FIG. 1B is a detail view of FIG. 1A.

FIG. 2 illustrates switched logic circuits in accordance with an embodiment.

FIG. 3 illustrates a helmet and goggles with active shutter lenses and multiple embedded receivers corresponding to an embodiment.

FIG. 4 illustrates pince-nez with active shutter lenses and multiple embedded receivers corresponding to an embodiment.

FIG. 5 illustrates a front view of 3-D glasses having closely spaced multiple embedded receivers corresponding to an embodiment.

FIG. 6 illustrates 3-D glasses with a removable receiver corresponding to an embodiment.

FIG. 7 illustrates 3-D glasses with an alternate removable receiver corresponding to an embodiment.

FIG. 8 illustrates 3-D glasses with a kit of removable, swappable receivers corresponding to an embodiment.

FIG. 9 is a signal-wire diagram of a receiver module corresponding to an embodiment.

FIG. 10 illustrates a flowchart of a process in accordance with an embodiment.

### DETAILED DESCRIPTION

Active shutter 3-D stereoscopic glasses with multiple receivers for multiple brands and/or models 3-D televisions are presented. In some embodiments, multiple IR receivers are embedded in the frames of the glasses selected by a user-selectable mechanical or software switch. Decoding logic can be downloaded from a PC or other networked device from the Internet. Alternatively, the decoding logic can be already onboard the glasses but be automatically selected by software or firmware in the 3-D glasses. The selection can be automatic by holding the glasses up to a 3-D TV synchronization transmitter and depressing a ‘program’ button. In some embodiments, decoding of the transmitted signal can be additionally augmented by comparison to the displayed images on the TV. In other embodiments, separate receivers can be plugged into the glasses and swapped out by an end user.

Each different receiver and associated logic can be capable of receiving and processing a different center frequency. For example, one infrared receiver can receive pulse width modulation (PWM) encoded signals at a 25 kHz carrier frequency, and another infrared receiver can receive PWM encoded signals at 28 kHz. Still another infrared receiver can receive PWM encoded signals at 27 kHz.

Associated logic circuits may be able to decode signals encoded in a particular proprietary encoding scheme. For example, one logic circuit can decode signals received from a Sony 3-D television, and another logic circuit can decode signals from a Panasonic 3-D television.

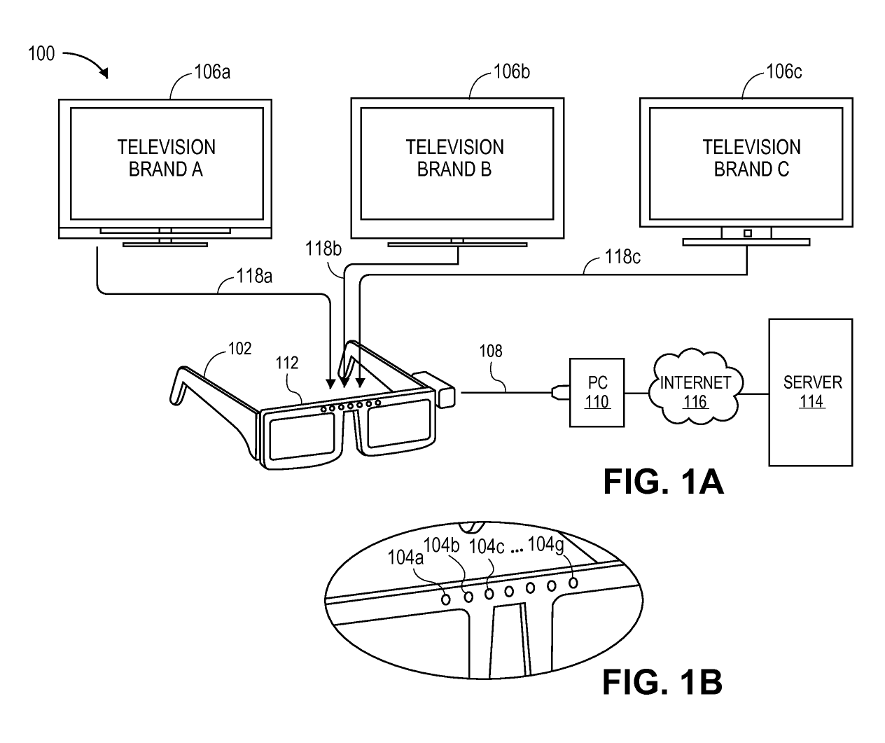

FIGS. 1A-1B illustrate 3-D glasses with multiple receivers in accordance with an embodiment. In glasses 102, multiple receivers 104a-g are embedded in frames 112. Each receiver 104a-g corresponds with one or more brands or models of 3-D capable televisions.

For example, receiver 104a corresponds with television brand 106a, receiver 104b corresponds with television brand 106b, etc. Each receiver can be at a different IR center frequency F0 or there may be some overlap between the frequencies that the different IR receivers cover. Some receivers can receive other electromagnetic radiation wavelengths, such as RF.

Each television 106 has its own proprietary signal pattern. After being received by one of receivers 104a-g, the signal pattern is demodulated or otherwise decoded by circuit logic. The logic may be hardwired or firmware or software based.

In some embodiments, logic can be downloaded off of the Internet from a centralized server. A user can connect glasses 102 by a universal serial bus (USB) cable 108 to personal computer (PC) 110. In other embodiments, the glasses can connect wirelessly to PC 110. The PC can connect via Internet 116 or other network to server 114. Server 114 queries a database for an algorithm corresponding to the brand and/or model of the particular TV with which the user is trying to synchronize the glasses. Once the algorithm is found, it can be downloaded to the glasses and stored as software or ‘burned’ as firmware.

To enable a selection of the algorithm or logic, the glasses themselves can record an IR waveform from the TV. Glasses 102 record signal 118 from television 106, and a digital representation of recorded signal 118 is sent to server 114. Server 114 can compare the recorded signal to a centralized database of waveforms and match the most compatible waveform. Server computer 114 can then send out decoding logic corresponding to the compatible waveform to glasses 102 where the logic can be stored for use in decoding the signal.

In some embodiments, the glasses can be automatically programmed onboard the glasses without hooking to an off-board server. To program the glasses for use with a particular 3-D television, a user can enable the 3-D synchronization IR transmitter port on the TV and then hit a button (not shown) on the glasses and hold them up to the TV. While all the receivers are powered on, logic on the glasses can sample each of the multiplexed receivers to determine the receiver with the best signal strength. The logic can then attempt to decode the signal from the receiver with the best signal strength. If the decoded signal matches a code from a lookup table, then the logic selects that receiver and that code for later use.

Four to six IR receivers can be mounted on the glasses to cover center frequencies of many, if not most, major 3-D TV brands. TV manufacturers often purchase IR transmitters from a limited set of suppliers. Because of this, some TV manufacturers use the same IR transmitters as others, and their proprietary glasses use common IR receivers. This inadvertent, de facto commonality in components enables embodiments to service many TV brands with relatively few IR receivers. As few as 4 to 6 (or 8) different IR receivers have been identified as being compatible with most major brands of 3-D televisions.

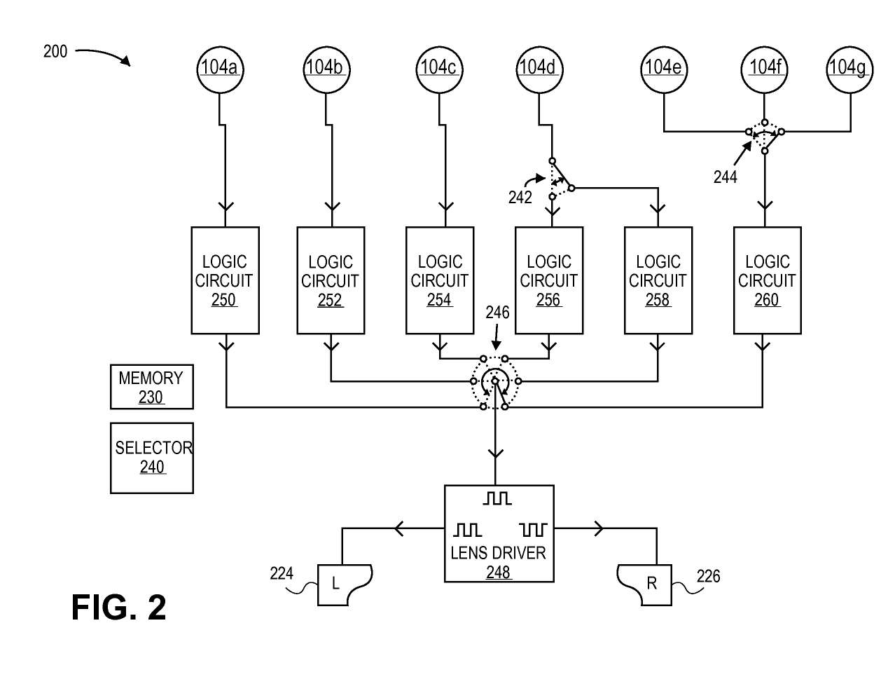

FIG. 2 illustrates switched logic circuits in accordance with an embodiment. Switched logic system 200 includes receivers 104a-g connected either directly to logic circuits or through a switch to the logic circuits. As shown, receivers 104a, 104b, and 104c are directly connected with logic circuits 250, 252, and 254. Each model of the respective 3-D televisions has a distinct IR center frequency F0 and waveform. Receiver 104d connects via single pole, double throw (SPDT) switch 242 to either logic circuit 256 or 258. This is because two different 3-D television brands share the same IR center frequency F0 but have different waveforms. For example, the televisions may transmit at the same 25 kHz carrier frequency, but one is PWM encoded and the other is a phase modulated signal. Thus, the receiver is different but the decoding logic is the same. Receivers 104e-g connect via single pole, triple throw (SPTT) switch 244 to logic circuit 260. Three different 3-D television brands have different IR center frequencies F0 and best require three different receivers but have the same waveform. For example, the televisions may transmit at 25 kHz, 27 kHz, and 28 kHz carrier frequencies but all are PWM encoded with the same algorithm. The output of each logic circuit 250-260 is normalized to a standard output format before passing on to the next component.

In some embodiments, a software switching method can be implemented. A selection can be stored in memory, such as memory 230, and the selection in memory 230 can read by selector 240 in order to set switches 242, 244, and/or 246 to select the proper receiver and decoding logic circuit. All may be controlled by a common bus or separate conductors running from each switch gate.

The outputs of all logic circuits 250-260 are multiplexed or otherwise switched by switch 246 so that only one output proceeds to lens driver 248. Lens driver 248 conditions signals coming from switch 246 so that the proper lens opacity and transmissivity voltages and currents are sent to lenses 224 and 226. In the exemplary embodiment, lens driver 248 simply amplifies the input (and adds a bias if necessary) to form the output that goes to left lens 224 and logically NOTs the same input signal (and adds a bias if necessary) to form the output that goes to right lens 226. In this way, the left lens is blocked (i.e., opaque) when the right lens is clear (i.e., transparent).

Further conditioning can occur in the lens driver. For example, during a transition there may need to be a voltage held high for a short overlap period to both the currently opaque lens, which is switching from opaque to transparent, and the currently transparent lens. The short overlap period can ensure that the left/right opacity/transmissivity of the glasses crisply changes between the two lenses even though there may be a time delay for liquid crystals in the opaque lens to respond to the rising voltage.

Three-dimensional active shutter glasses can come in different forms with different configurations, some of which are shown in the following figures.

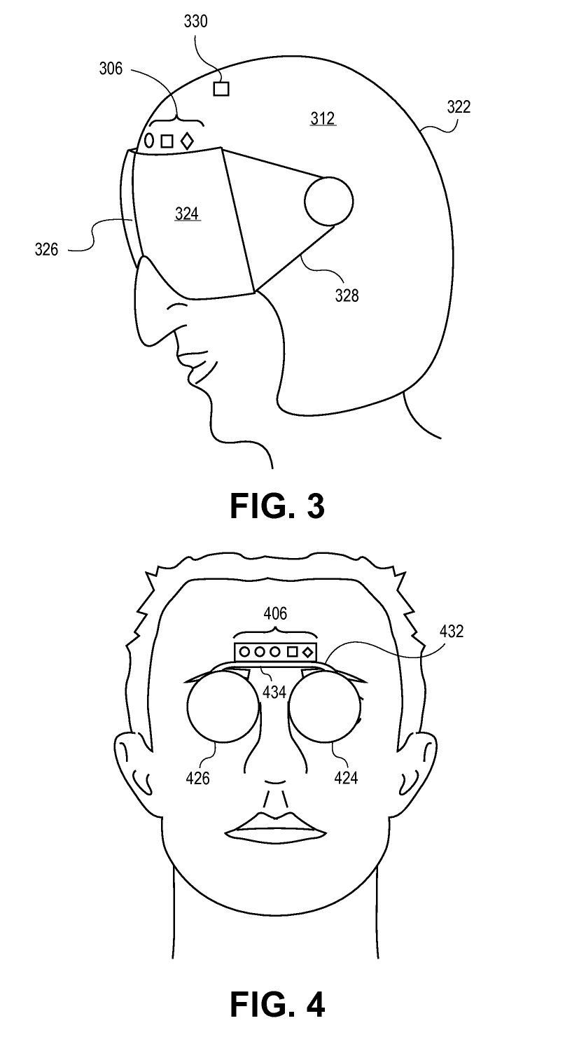

FIG. 3 illustrates a helmet with active shutter lenses and multiple embedded receivers. Helmet 322 may be sold with race car, fighter pilot, or other theme video games that are 3-D enabled. Helmet 322 includes multiple receivers 306 embedded in its shell or frame 312. In some embodiments, the receivers can be directly mounted to visor flip down portion 328, which includes goggle lenses 324 (left) and 326 (right). Likewise, memory 330, which can store the selection of the receiver and/or logic circuit, can be directly attached to flip down portion 328 or to frame 312 (as shown).

In some embodiments, different flip down portions or goggle lenses may be swapped out from the helmet along with different receivers. For example, one flip down portion may be optimized in polarity, color, etc. for a particular line of TVs, and another flip down portion may be optimized for another line of TVs. The receiver(s) for the first line of

TVs can be mounted on the first flip down portion, and the receiver(s) for the second line of TVs can be mounted on the second flip down portion.

FIG. 4 illustrates minimalist pince-nez with active shutter lenses 424 and 426 and multiple receivers 406. In the exemplary embodiment, multiple IR receivers 406 are mounted on bridge piece 434 of pince-nez 432. Spectacles, pince-nez, monocles, binoculars, contact lenses, and other means for a wearer to don a lens or lenses in front of his or her eyes are contemplated. Lenses may wrap around the sides of a user's face or be minimalist, mounted just in front of the user's eyes.

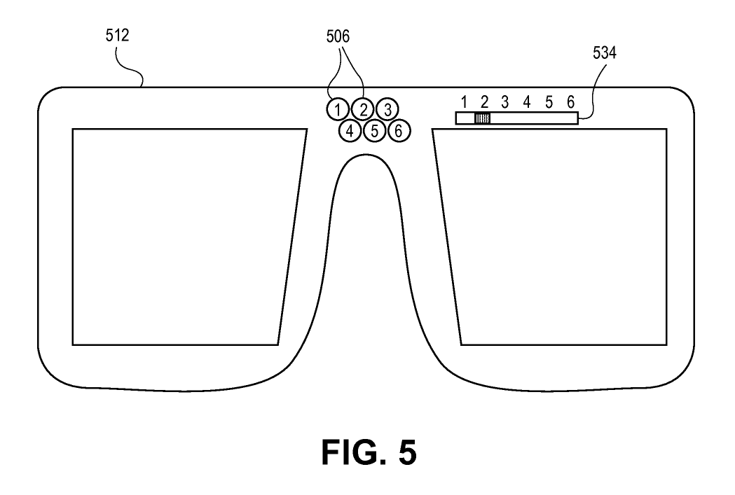

FIG. 5 illustrates a front view of 3-D glasses having closely spaced multiple embedded receivers corresponding to an embodiment. Multiple circular IR receivers 506 are stacked closely together to conserve space on glasses frames 512 as well as to aid in manufacturing.

Because universal remote controls for televisions use devices that purposely emit radiation (i.e., transmitters), there can be limits to how close the devices may be put together with each other before suffering electromagnetic interference (EMI). In the exemplary embodiment, each of IR receivers 506 passively receives and does not transmit. Electromagnetic interference between the devices can be less than that of equivalently powered transmitters. Because there is minimal electromagnetic interference, the IR receivers can be closely stacked together.

Slider switch 534, a mechanical switch, can be repositioned by the user in order to control the circuit selections. In the exemplary embodiment, numbers on the bezel of the slider switch (i.e., 1, 2, 3, etc.) match those of the receivers. When a user selects “2” on the mechanical switch, the 2nd receiver is activated and the other receivers are turned off. Slider switch 534 can operatively coupled with other switches (e.g., switches 242, 244, and 246 of FIG. 2) in order to properly route signals.

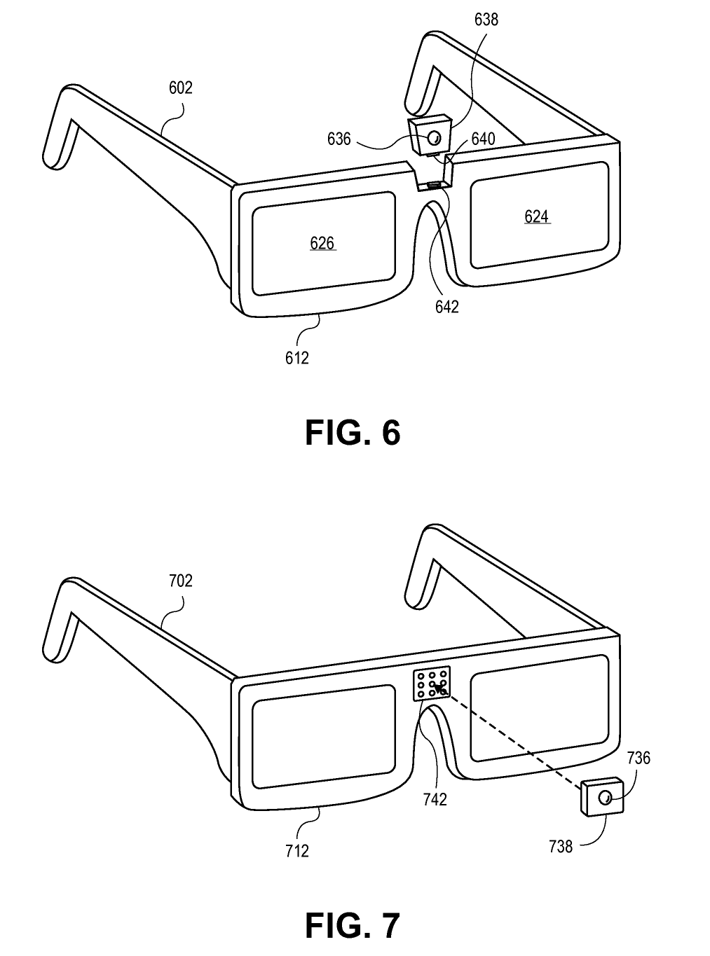

FIG. 6 illustrates 3-D glasses with a removable, swappable receiver being inserted into a form-fitting recess. IR receiver 636 is housed in removable housing 638 with electrical connector 640. Electrical connector 640 plugs into electrical receptacle 642 on frame 612 of glasses 602. A U-shaped recess around electrical receptacle 642 intimately form fits with removable housing 638 and may include protrusions and recesses to better secure the receiver to the glasses. The connector may be removable from the receptacle or may be a one-time, snap in fit.

When plugged in, receiver 636 connects with a driver onboard the glasses for lenses 624 and 626. IR or RF wireless signals received by receiver 636 synchronize the lenses to the transmitting 3-D television.

A logic circuit for receiver 636 can be in the glasses 602 or in removable housing 638. If located in removable housing 638, then multiplexing or switching between logic circuits may be unnecessary as there is only one receiver, thus simplifying manufacturing.

The removable receiver can be marketed and sold separately from the glasses. Several different receivers corresponding to different television models can be sold on store shelves near the glasses. A consumer can buy the receiver corresponding to his or her television without purchasing unnecessary receivers.

FIG. 7 illustrates an alternate removable receiver module. Receiver 736 in module 738 plugs into receptacle 742 on the front of glasses 702. Form factors for removable modules can vary from a proprietary design of the connectors to a standardized design. Examples of such designs include a miniSD card and Sony Memory Sticks. Various locations and modes for attachment of the receiver to the glasses are readily apparent to one skilled in the art.

Some embodiments include removable receiver modules that attach by snapping, plugging, fastening by hook & loop fastener (e.g., VELCRO®), adhering with releasable or other adhesives, etc. onto the front, sides, or other locations on the glasses frames.

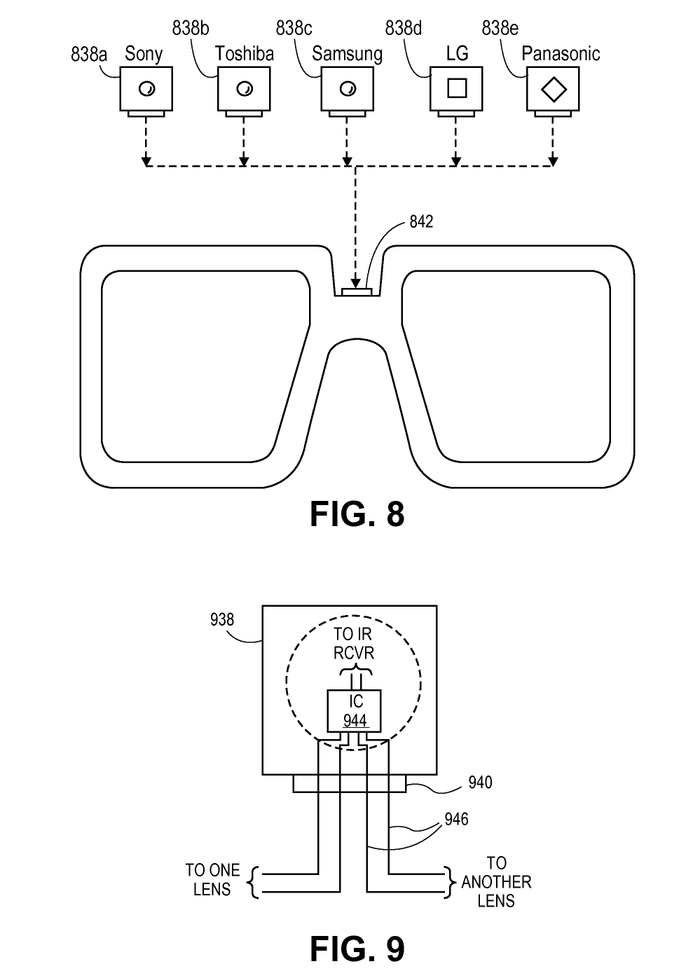

FIG. 8 illustrates 3-D glasses with a kit of removable, swappable receiver modules. Each receiver 838a-e corresponds to a different brand and/or model of television. For example, receiver module 838a corresponds to a Sony 3-D television and includes logic for most, if not all, models of Sony 3-D televisions. Receiver module 838b corresponds with a Toshiba 3-D television and includes logic for models of Toshiba 3-D televisions. Other modules can include a radio frequency receiver configured to receive BLUETOOTH® formatted wireless signals. The glasses may use a wireless network, such as an Institute of Electrical and Electronics Engineers (IEEE) standard 802.11 network and may in such instances act as its own network device.

FIG. 9 is a simplified signal-wire diagram of a receiver module. Power wires and other supporting connections are not shown. Signal wires from an IR receiver enter integrated circuit (IC) 944, which can have many of the components and connections illustrated in FIG. 2. IC 944 has firmware, or software in memory, to decode a particular coding scheme used by a manufacturer's television. Signal wires 946, which may contain enough power to drive active shutter lenses, then go from the IC to the left and right lenses of the 3-D glasses.

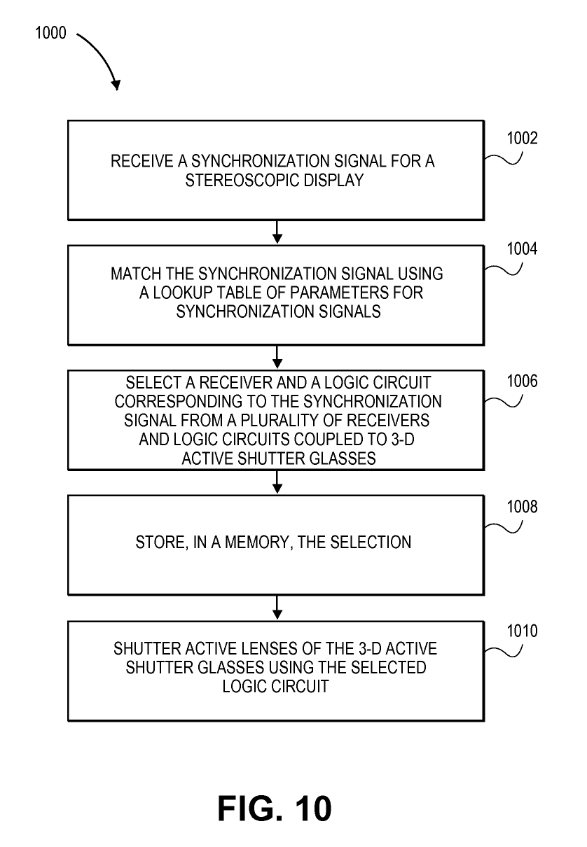

FIG. 10 is a flowchart illustrating process 1000 in accordance with one embodiment. In operation 1002, a synchronization signal for a stereoscopic display is received. In operation 1004, the synchronization signal is matched using a lookup table of parameters for synchronization signals. In operation 1006, a receiver and a logic circuit corresponding to the synchronization signal are selected from a plurality of receivers and logic circuits coupled to 3-D active shutter glasses. In operation 1008, the selection is (optionally) stored in a memory. In operation 1010, active lenses of the 3-D active shutter glasses are shuttered using the selected logic circuit.

The operations may be performed in the sequence given above or in different orders as applicable. They can be automated in a computer or other machine and can be coded in software, firmware, or hard coded as machine-readable instructions and run through one or more processors that can implement the instructions.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. An apparatus for viewing a stereoscopic display, comprising:
a pair of active shutter lenses, each lens enabled to alternate opacity and transparency;
means for positioning the lenses in front of a viewer's eyes;
a plurality of receivers including a first receiver configured to receive a first synchronization signal and a second receiver configured to receive a second synchronization signal;
a circuit connected to the active shutter lenses and plurality of receivers, the circuit configured to control alternating opacity and transparency of the lenses based on a selected synchronization signal; and
a selector operatively coupled to the circuit, the selector enabled to select the selected synchronization signal from one of the first and second synchronization signals.

2. The apparatus of claim 1 wherein the first synchronization signal is at a first center frequency and the second synchronization signal is at a second center frequency.

3. The apparatus of claim 1 further comprising:
a memory, wherein the memory stores information regarding which receiver to use for the selected synchronization signal.

4. The apparatus of claim 3 wherein the circuit is configured to automatically identify a suitable signal from one the receivers and store information in the memory about the respective receiver.

5. The apparatus of claim 1 wherein the selector comprises a mechanical switch.

6. The apparatus of claim 1 wherein the selector comprises a software-selectable switch.

7. The apparatus of claim 1 wherein the first synchronization signal is coded using a technique selected from the group consisting of pulse width modulation and phase modulation.

8. The apparatus of claim 1 wherein the active shutter lenses include liquid crystals.

9. The apparatus of claim 1 wherein the receiver includes a receiver selected from the group consisting of an infrared receiver and a radio frequency receiver.

10. An apparatus for viewing a stereoscopic display, comprising:
a frame;
active shutter lenses attached to the frame, each lens enabled to alternate opacity and transparency;
an electrical connector attached to the frame;
a first removable receiver removably attached to the electrical connector, the first removable receiver configured to receive a first synchronization signal; and
a circuit connected to the electrical connector and active shutter lenses, the circuit configured to control alternating opacity and transparency of the lenses based on a synchronization signal received by the first removable receiver.

11. The apparatus of claim 10 further comprising:
a second removable receiver configured to receive a second synchronization signal,
wherein the second removable receiver is configured to removably attach to the electrical connector and thereby connect with the circuit to control alternating opacity and transparency of the lenses based on a synchronization signal received by the second removable receiver.

12. The apparatus of claim 11 wherein the first removable receiver comprises an infrared receiver having a first center frequency and the second removable receiver comprises an infrared receiver having a second center frequency.

13. The apparatus of claim 11 wherein the first removable receiver comprises an infrared receiver and the second removable receiver comprises a radio frequency receiver.

14. A method of operating 3-D active shutter glasses, the method comprising:
receiving a synchronization signal for a stereoscopic display;
selecting a receiver and a logic circuit corresponding to the synchronization signal from a plurality of receivers and logic circuits coupled to 3-D active shutter glasses;
storing in a memory the selection; and
shuttering active lenses of the 3-D active shutter glasses using the selected receiver and logic circuit.

15. The apparatus of claim 14 wherein during the selection the plurality of logic circuits process the synchronization signal simultaneously.

16. The apparatus of claim 14 wherein the logic circuit comprises a firmware circuit.

17. The apparatus of claim 14 wherein the logic circuit comprises software loaded into a memory.

18. The apparatus of claim 14 wherein the selecting occurs automatically.

19. The apparatus of claim 18 wherein the selecting comprises:
matching the synchronization signal using a lookup table of parameters for synchronization signals.

20. The apparatus of claim 14 wherein the selecting is designated through a mechanical switch.
